(19) United States
(12) Patent Application Publication
(10) Pub. No.: US 2018/0093708 A1
(43) Pub. Date: Apr. 5, 2018

(54) STEERING AXLE FOR SELF-PROPELLED WINDROWER

(71) Applicant: AGCO Corporation, Duluth, GA (US)

(72) Inventor: Daniel J. Soldan, Hillsboro, KS (US)

(21) Appl. No.: 15/723,262

(22) Filed: Oct. 3, 2017

Related U.S. Application Data
(60) Provisional application No. 62/403,277, filed on Oct. 3, 2016.

(51) Int. Cl. B62D 9/00; B62D 7/08; B62D 11/00; A01B 69/08; A01B 69/00

(52) U.S. Cl. CPC B62D 9/002; B62D 7/08; B62D 11/003; A01B 69/007; B62D 11/008; A01B 69/006; B62D 11/005

(57) ABSTRACT

In one embodiment, a windrower that comprises: a dual-path steering system configured to drive a pair of drive wheels in an opposite direction of rotation and in a same direction of rotation during non-overlapping time periods; and a steering axle system configured to actively steer a pair of caster wheels while the dual path steering system drives the pair of drive wheels during each of the non-overlapping time periods.

### CROSS REFERENCE TO RELATED APPLICATION

This application claims the benefit of U.S. Provisional Application No. 62/403,277 filed Oct. 3, 2016, which is hereby incorporated by reference in its entirety.

### TECHNICAL FIELD

The present disclosure is generally related to agricultural machines and, more particularly, self-propelled windrowers.

### BACKGROUND

Self-propelled windrowers utilize a dual-path steering system to achieve maximum maneuverability while cutting crops in the field. Such dual-path steered, self-propelled windrowers have drive wheels in front and freely-rotating caster wheels in back. Dual-path steering is desirable during field operations for quick and efficient turn arounds in headlands. However, during high-speed field or road operations, steering control can be sluggish and unstable due at least in part to the location of the machine's center-of-gravity and the nature of the steering method.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates, in top fragmentary plan view, an embodiment of an example windrower equipped with an embodiment of an example steering axle system.

FIG. 2A is a schematic diagram that illustrates a fragmentary front elevation view of an embodiment of a portion of an example steering axle system.

FIG. 2B is a schematic diagram that illustrates a fragmentary front elevation view of another embodiment of a portion of an example steering axle system.

FIGS. 3A-3H are schematic diagrams that illustrate diagrammatic overhead fragmentary views of wheel positioning for various movements of an example windrower using an embodiment of an example steering axle system.

FIG. 4A is a block diagram of an embodiment of an example control system for a steering system comprising an embodiment of an example steering axle system.

FIG. 4B is a block diagram of an embodiment of an example controller for the example control system of FIG. 4A.

FIG. 5 is a flow diagram that illustrates an embodiment of an example method of steering.

### DESCRIPTION OF EXAMPLE EMBODIMENTS

### Overview

In one embodiment, a windrower that comprises: a dual-path steering system configured to drive a pair of drive wheels in an opposite direction of rotation and in a same direction of rotation during non-overlapping time periods; and a steering axle system configured to actively steer a pair of caster wheels while the dual path steering system drives the pair of drive wheels during each of the non-overlapping time periods.

### Detailed Description

Certain embodiments of a steering axle system and method are disclosed that provides for active or positive steering of rear caster wheels of a windrower during field operations while the windrower maintains zero-turning-radius capabilities. In one embodiment, a steering axle system comprises an axle, a pair of forks rotatably coupled to opposing ends of the axle, and a pair of caster wheels operably coupled to the respective pair of forks, the pair of caster wheels centered beneath the axle. The positioning of the pair of caster wheels beneath the axle enables active steering of the caster wheels at all times, with the angle of rotation of each of the caster wheels comprising in one embodiment a range of zero to one hundred eighty degrees, and in some embodiments, an infinite rotational range (e.g., zero to three hundred sixty degrees) depending on the choice of actuator.

Digressing briefly, a windrower equipped with certain embodiments of a steering axle system includes a steering system that includes a dual-path system and the steering axle system. With the dual-path system, such a windrower according to the disclosed embodiments may still drive and operate at times like a typical windrower in the sense that steering may be accomplished through differential wheel speeds. However, whereas typical windrowers use one or more tailwheel casters that trail the rear axle and are free to rotate about a vertical axis, certain embodiments of the steering axle system enable direct control (active control) of the rear caster wheels at all times (e.g., during the periods of time of counter rotation of the front drive wheels or rotation according to the same direction of the front drive wheels). Through the use of certain embodiments of a steering axle system, quick and efficient turn arounds at headlands are still achieved, while adding stability and responsiveness to steering for high-speed field or road operations.

Having summarized certain features of a steering axle system of the present disclosure, reference will now be made in detail to the description of the disclosure as illustrated in the drawings. While the disclosure will be described in connection with these drawings, there is no intent to limit it to the embodiment or embodiments disclosed herein. For instance, though emphasis is placed on a machine in the agricultural industry, and in particular, a self-propelled windrower, certain embodiments of a steering axle system may be beneficially deployed in other machines (in the same or other industries) where stable navigations operation is desired and/or where zero radius turn functionality is implemented. Also, the below embodiments are described using a pair of forks for implementing the rear caster wheel attachments, though it should be appreciated by one having ordinary skill in the art, in the context of the present disclosure, that other rear wheel attachments may be used. For instance, a formed spindle may be used in place of each fork, where the caster trail is likewise removed and each caster wheel is positioned below the respective axis of rotation. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the windrower looking forwardly.

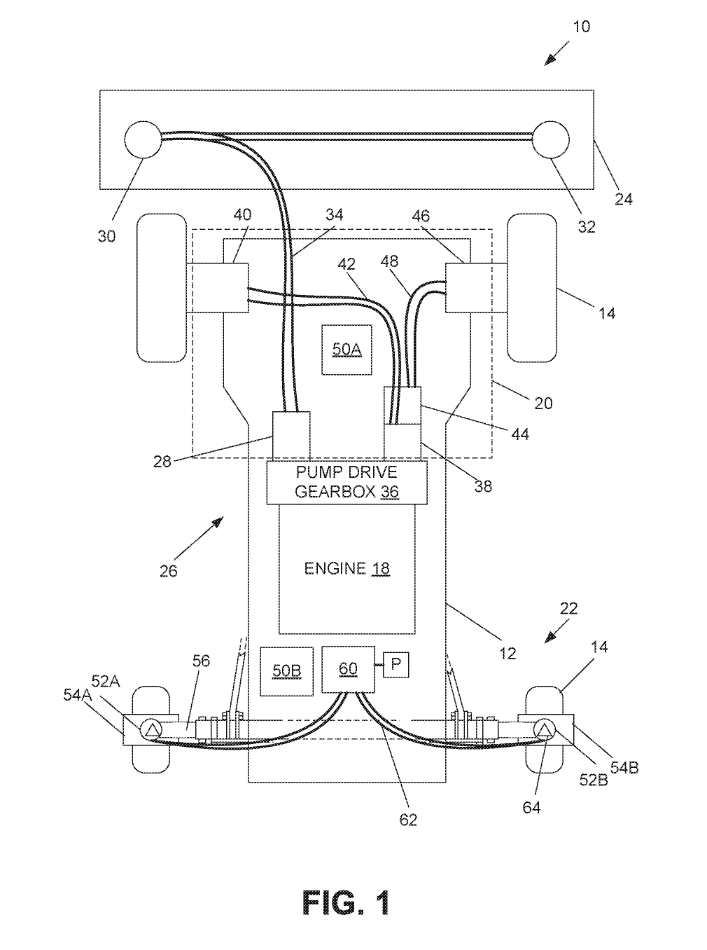

Reference is made to FIG. 1, which illustrates an example agricultural machine where an embodiment of a steering axle system may be implemented. One having ordinary skill in the art should appreciate in the context of the present disclosure that the example agricultural machine, depicted in FIG. 1 as a self-propelled windrower 10, is merely illustrative, and that other machines and/or components with like functionality may deploy certain embodiments of a steering axle system. The self-propelled windrower 10 is operable to mow and collect standing crop in the field, condition the cut material as it moves through the machine to improve its drying characteristics, and then return the conditioned material to the field in a windrow or swath. In some implementations, the windrower 10 may tow an implement (not shown). The windrower 10 may include a chassis or frame 12 supported by a pair of front drive wheels 14 (although tracks may be used in some embodiments, or other configurations in the number and/or arrangement of wheels may be used in some embodiments) and a pair of rear caster wheels 16 for movement across a field to be harvested. In some embodiments, the amount of wheels 14 and/or 16 may be different. As is known, the chassis 12 further carries a cab (not shown), within which an operator may control certain operations of the windrower 10, and a rearwardly spaced compartment housing a power source, which in the depicted embodiment, comprises an internal combustion engine 18. The chassis 12 also supports a steering system that includes a dual-path steering system 20 (which is part of a ground drive system) and a steering axle system 22, each explained further below.

A coupled working implement, depicted in FIG. 1 as a harvesting header 24, is supported on the front of the chassis 12 in a manner understood by those skilled in the art. The header 24 may be configured as a modular unit and consequently may be disconnected for removal from the chassis 12. As is also known in the art, the header 24 has a laterally extending crop cutting assembly in the form of a low profile, rotary style cutter bed located adjacent the front of the header 24 for severing crop from the ground as the windrower 10 moves across a field. However, one skilled in the art will understand that other types of crop cutting assemblies 24, such as sickle style cutter beds, may also be used in some embodiments. During a harvesting operation, the windrower 10 (with or without a towed implement) moves forward through the field with the header 24 lowered to a working height.

The windrower 10 comprises a ground drive system 26 that includes the dual-path steering system 20. The windrower 10 also includes a header drive system that comprises a header drive pump 28 that is fluidly coupled to header drive motors 30 and 32 via hydraulic fluid lines, including hydraulic fluid line 34, as is known. The ground drive system 26 is powered by the engine 18, which is mounted to the chassis 12. The ground drive system 26 comprises a pump drive gearbox 36 that is coupled to the engine 18. The ground drive system 26 further comprises the dual-path steering system 20, which includes a left wheel propel pump 38 coupled to the pump drive gearbox 36, and further coupled to a left wheel drive motor 40 via hydraulic fluid lines, including hydraulic fluid line 42. The dual-path steering system 20 of the ground drive system 26 also comprises a right wheel propel pump 44 coupled to the pump drive gearbox 36, and further coupled to a right wheel drive motor 46 via hydraulic fluid lines, including hydraulic fluid line 48. Although depicted as comprising a by-wire system, other hydraulic mechanisms may be used to facilitate ground transportation in some embodiments, and hence are contemplated to be within the scope of the disclosure.

The dual-path steering system 20 further comprises a controller 50A. For dual-path steering operations, in one embodiment, software in the controller 50A provides for control of the ground drive system 26, including the dual-path steering system 20. Sensors are located on or proximal to the machine navigation controls, or generally, a user interface (e.g., which includes the steering wheel and the forward-neutral-reverse (FNR) lever) in the cab of the windrower 10, where operator manipulation of the steering wheel and/or FNR lever causes movement of the same that is sensed by the sensors. These sensors feed signals to the controller 50A, which in turn provide control signals to the propel pumps 38 and 44 to cause movement of the windrower 10 according to the requested speed and travel direction. The signaling from the controller 50A causes a change in fluid displacement in the respective propel pumps 38 and 44, each displacement in turn driving the respective wheel drive motors 40 and 46 via hydraulic fluid lines 42 and 48. In general, dual-path steering is generally achieved through adjustment of differential speeds of the two drive wheels 14 in coordination with active steering by the steering axle system 22, the latter described further below. In some embodiments, the dual-path steering system 20 may comprise additional or fewer components.

As to the drive wheels 14, rotating the steering wheel may increase the speed of one drive wheel 14 (e.g., left) while slowing the speed of the other drive wheel 14 (e.g., right) by the same amount. In other words, steering for the windrower 10 may be achieved by increasing the speed of one drive wheel 14 while decreasing the speed of the opposite drive wheel 14 by the same amount (both drive wheels 14 may rotate at the same speed in the same direction or when in counter-rotation). Using some example values for illustration, if the windrower 10 is traveling at 5 miles per hour (MPH) forward, a steering command may result in the left drive wheel 14 driven at a speed of 6 MPH and the opposing right drive wheel 14 driven at a speed of 4 MPH, resulting in a right hand turn. As another example, if the windrower 10 is traveling forward at 1 MPH, the same steering command may result in the left drive wheel 14 being driven at 2 MPH forward and the opposing right drive wheel 14 driven to a complete stop (or equivalently, permitted to stop), with the magnitude of the difference in each case (e.g., 2 MPH) between the two drive wheels 14 being the same. At slower ground speeds, the drive wheels 14 may counter-rotate, where one drive wheel 14 is driven in the forward direction and the opposing drive wheel 14 is driven in reverse, causing the windrower 10 to spin in a zero radius turn. The zero radius turn is enabled during the neutral position of the FNR lever, and as described above, involves the drive wheels 14 rotating in opposite directions (e.g., while the left front drive wheel 14 is rotating in a clockwise direction, for instance, the right front drive wheel 14 is rotating in a counter-clockwise direction). Stated otherwise, for the zero radius turn function, the front drive wheels are driven (e.g., via the propel pumps 38 and 44 and wheel drive motors 40 and 46, as commanded or signaled by the controller 50A) in opposite directions (respectively forward and reverse). Continuing the illustrative examples described above, for a similar steering command and operation in neutral, the command results in the left drive wheel 14 driven at a speed of 1 MPH forward and the right drive wheel 14 driven 1 MPH in reverse (causing the windrower 10 to counter rotate to the right). The zero radius turn is a typical field operation used to achieve maximum maneuverability. Because of the manner of operation in dual-path steering, it is noted that the windrower 10 steers backwards when traveling in reverse (e.g., rotating the steering wheel to the left while backing up causes the windrower 10 to turn to the right, referred to as “S-steering”). At the same time, as noted above, the rear caster wheels 16 are also under active steering control using steering commands that are coordinated with those provided for controlling operations of the front drive wheels 14.

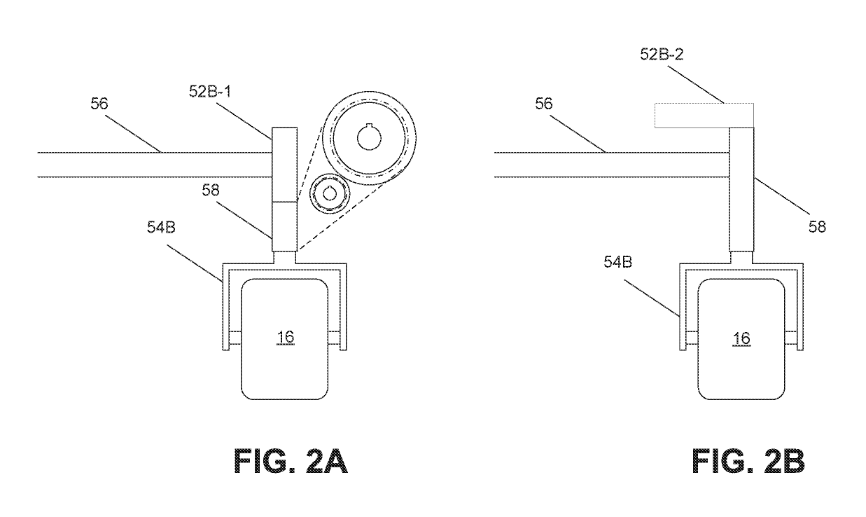

Referring now to the steering axle system 22, in one embodiment, the steering axle system 22 comprises a pair of actuators 52A, 52B (collectively, actuators 52), a pair of rear wheel attachments, including a pair of forks 54A, 54B (collectively, forks 54), a controller 50B, and an axle 56. As indicated above, though shown and described using a pair of forks 54, in some embodiments, a pair of formed spindles may be used for the rear wheel attachments, such as those used in the WR9800 Series SP Massey Ferguson windrowers. In such embodiments, each caster wheel 16 is positioned directly beneath (or substantially directly beneath) the axis of rotation. In some embodiments, the steering axle system 22 may comprise additional or fewer components. The axle 56 extends transverse to a longitudinal axis of the windrower 10, and has opposing ends to which the forks 54A, 54B are respectively coupled. Focusing on the steering axle system 22 for the right hand side of the windrower 10 (with the understanding that the structure and function described for the right hand side of the windrower 10 is similarly applicable to the left hand side), and with reference to FIGS. 1 and 2A, the fork 54B straddles and is coupled to the wheel 16 and also to a gear set 58 (the gear set schematically shown in FIG. 2A). For instance, the gear set 58 may be comprised of plural gears, each of a different size (e.g., different radius), to provide a desired gear ratio. In some embodiments, at least one of the gears of the gear set 58 may be a partial gear (e.g., half, quarter, third, etc.) to reduce weight. In some embodiments, the gear set 58 may be replaced with a crank arm assembly (e.g., bellcrank) or other known mechanisms for translating the rotational motion of a rotary actuator 52B-1 (e.g., a hydraulic cylinder where the rod and core are splined) to the rotation the fork 54B (and hence the same or proportional rotation of the wheel 16). The rotary actuator 52B-1 in turn is coupled to the axle 56. In one embodiment, coupling between the rotary actuator 52B-1 and the axle 56 may be achieved via a flange, threaded connection, or other known attachment mechanisms. The rotary actuator 52B-1 may be provided by one of a plurality of different manufacturers, including Helac rotary actuators, and though depicted as a hydraulic-type rotary actuator, other types of rotary actuators may be used, including pneumatic, electric, magnetic, or electromagnetic type actuators. As indicated above, the rotation provided by the rotary actuators 52B-1 (and hence the wheel rotation) may be in an angular range of zero to one hundred-eighty degrees, or in some embodiments, a greater range (e.g., infinite or three hundred-sixty degrees rotational range). As is best shown in FIG. 1, the wheels 16 are centered beneath the axle 56. In other words, from an overhead plan view, the wheel 16 has an equal or substantially equal amount of area exposed fore and aft of the axle 56. Note that in embodiments with a different axle design, the vertical axis of rotation may be located slightly forward or aft of the axle. In some embodiments, and referring to FIGS. 1 and 2B, the actuator 52B-2 may be comprised of a rod and piston type actuator (e.g., a linear hydraulic cylinder, though not limited as such) that is oriented in parallel or substantially parallel relationship to a longitudinal axis of the axle 56, though not limited to a parallel orientation. Again, the actuator 52B-2 may engage a gear set 58 or crank assembly to cause rotation (e.g., one hundred-eighty degrees) of the fork 54B (and hence rotation of the wheel 16). Similar to the rotary actuator 52B-1, the linear actuator 52B-2 may be embodied as hydraulic, pneumatic, electric, magnetic, or electromagnetic type actuators. In some embodiments, the actuators 52 may be replaced with a motor that engages the gear set 58 (or crank assembly) directly.

In one embodiment, and particularly for fluid-type (e.g., hydraulic-type) actuators, control of the actuators 52 may be achieved via the controller 50B in cooperation with one or more manifolds 60 (one shown). Note that the location of the manifold 60 depicted in FIG. 1 is illustrative of one example, and that in some embodiments, the manifold(s) 60 may be located elsewhere (e.g., integrated with the assembly associated with the respective caster wheels 16). Also, in some embodiments, the manifold 60 may be omitted and control achieved directly via the controller 50B (e.g., for electric, magnetic, or electromagnetic-type actuators or motors). The manifold 60 comprises one or more control valves (e.g., electric, though not limited as such, and may have other sources of energy for control in some embodiments) that control the flow of hydraulic fluid into and out of ports of the actuators 52 via hydraulic fluid lines, including hydraulic fluid line 62. The manifold 60 is operably coupled to the controller 50B, the latter providing commands to the control valves in the manifold 60 based on input from any one or a combination of the controller 50A, the steering wheel and/or FNR lever in the cab, or one or more sensors. In some embodiments, functionality of the controller 50B may be integrated with the controller 50A, such that commands are provided to the control valves in the manifold 60 via the controller 50A. As would be appreciated by one having ordinary skill in the art, the manifold 60 is also fluidly coupled to a hydraulic pump (P) and reservoir (not shown). Focusing again on the steering axle system 22 located on the right hand side of the windrower 10 (with the same or similar applicability to the left hand side, the description of the same omitted here for brevity), in one embodiment, the actuator 52B (when embodied as a fluid power-type actuator) comprises known internal components that cause movement of the gear set 58 (or crank assembly) based on changes in differential pressure caused by the controller 50B and the control valves of the manifold 60 that receive commands from the controller 50B. For instance, the actuator 52B may comprise a linear piston and cylinder mechanism geared (e.g., via rack and pinion) to produce rotation, or may comprise a rotating asymmetrical vane that swings through a cylinder of two different radii. The differential pressure between the two sides of the vane gives rise to an unbalanced force and thus a torque on an output shaft that couples to the gear set 58 (or crank assembly). In non-rotary-type fluid-powered actuators, the actuator 52B may comprise a piston (or plural pistons in some embodiments) that slides back and forth within the housing of the actuator 52B based on hydraulic fluid displacement, as triggered and controlled by the control valves of the manifold 60 and conveyed over the hydraulic fluid lines 62. The actuator 52B may also comprise a rod that is coupled to, and moves synchronously with, the internal piston, which directly causes the gear set 58 (or crank assembly) to pivot or rotate (e.g., enabling rotation to the left and right) the fork 54B and hence the rear (right) caster wheel 16. In some embodiments, a sensor 64 (represented diagrammatically by a triangle, with a like sensor shown on the left hand side proximal to or integrated with the actuator 52A) may be used to sense the position of the caster wheel 16 (e.g., the steer-position), providing feedback to the controller 50B. In some embodiments, the sensor 64 may be located elsewhere to sense (directly or indirectly) the angle of the rear caster wheels 16. The controller 50B, in turn, provides commands to the control valve(s) of the manifold 60 based on the feedback from the sensor 64, enabling precise adjustment of the fluid displacement over the hydraulic fluid lines 62 into and out of the actuator 52B to enable a controlled or active adjustment of the steering position of the caster wheel 16. As noted above, a similar description applies to the left hand side caster wheel 16.

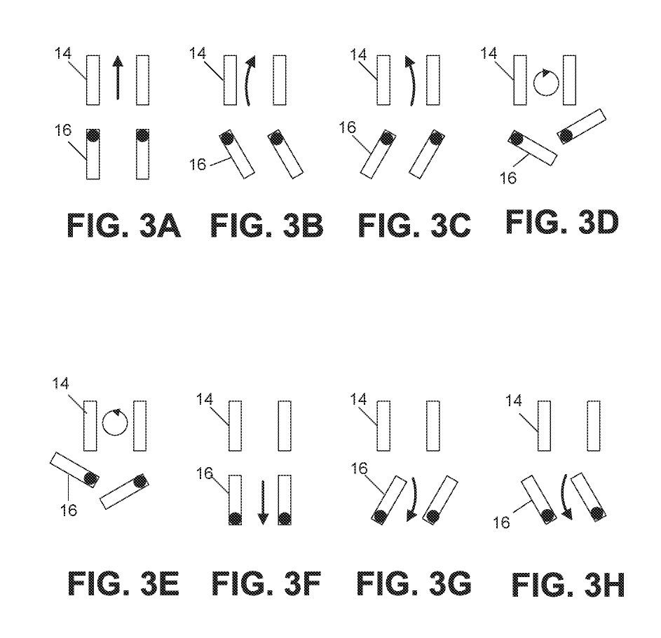

In one embodiment, software in the controller 50A provides for control of the ground drive system 26, including the dual-path steering system 20, and software in the controller 50B provides control for the steering axle system 22. In general, the caster wheels 16 operate according to a steer-rotation that is actively controlled while the dual-path steering is operational (e.g., both when operating according to zero-radius turns and all other steering or ground travel). Steering actions are coordinated between both the dual-path steering system 20 and the steering axle system 22. In one embodiment, a signal corresponding to a sensed steering wheel and/or FNR lever action is received at the controller 50A and translated into the appropriate magnitude (e.g., speed) and direction of rotation for controlling the front drive wheels 14. A signal sensing the steering wheel and/or FNR lever action may also be received at the controller 50B to enable the controller 50B to translate the steering wheel and/or FNR lever action into corresponding and respective steer commands (e.g., angles of steer) for the actuators 52 to enable adjustment to the appropriate steer angle for each of the rear caster wheels 16. In some embodiments, the controller 50A may determine all desired steer angles and communicate (e.g., via wired or wireless communication) the steer angles to the controller 50B. In some embodiments, the controller 50A may determine the required front wheel steer adjustment and communicate the adjustment to the controller 50B to enable determination by the controller 50B of the appropriately matched (e.g., see FIGS. 3A-3H) rear wheel steer adjustment. As indicated previously, functionality of the controllers 50A and 50B may be combined into a single controller (e.g., controller 50A).

Referring now to FIGS. 3A-3H, shown are some illustrations of front drive wheel 14 and rear caster wheel 16 orientations based on the direction of movement desired by the operator of the windrower 10 (FIG. 1). Notably with dual-path steering is that the front drive wheels 14 are always oriented straight (in parallel with each other) with the speed and direction of rotation of each wheel 14 adjusted as explained above to provide steering. The diagrams in FIGS. 3A-3H serve to illustrate that the rear caster wheels 16 are actively controlled at all periods of time (e.g., while the front drive wheels 14 are controlled). The black dot located on each of the rear caster wheels 16 signifies where the “front” of the rear caster wheel 16 is oriented. For instance, when driving the windrower 10 forward, the dot is shown at the front of the rear caster wheel 16, but when operating in reverse, the rear caster wheel 16 are controlled to rotate (e.g., during a period of time when the windrower 10 is positioned in one place) to enable the rear caster wheels 16 to turn around so that the reference dot is oriented at the front of the rearward movement (e.g., the front of the rear caster wheel 16 is turned around one hundred-eighty degrees to lead in the reverse direction). Also shown are arrow symbols to designate the direction of travel. With reference to FIG. 3A, the arrow depicts that the windrower 10 is to move in a forward direction. The front drive wheels 14 and the rear caster wheels 16 are oriented in the same direction, with the front of the rear caster wheels 16 as shown. In FIG. 3B, the arrow indicates that the windrower 10 is turning right (e.g., effected in part by adjustment by the dual-path steering system 20 (FIG. 1) of the relative rotation (e.g., speed and direction) of the drive wheels 14), with the steering axle system 22 (FIG. 1) effecting a suitable rotation of the rear caster wheels 16 to cause the rear caster wheels 16 to be oriented in parallel yet angled to the left (e.g., viewing the dot relative to the longitudinal axis of the windrower 10) to effect the right-hand turn. Similarly, yet in the opposite direction, in FIG. 3C, the arrow indicates that the windrower 10 is turning left, with the dual-path steering system 20 effecting an adjustment in relative rotation of the front drive wheels 14 while the steering axle system 22 effects a suitable rotation of the rear caster wheels 16 to cause the rear caster wheels 16 to be oriented in parallel yet angled to the right (viewing the dot relative to the longitudinal axis of the windrower 10) to effect the left-hand turn. FIG. 3D shows the front drive wheels 14 commanded by the dual-path steering system 20 to be in counter-rotation while the rear caster wheels 16 are commanded by the steering axle system 22 to be rotated such that the left rear caster wheel 16 is more acutely angled to the left (e.g., viewing the dot relative to the longitudinal axis of the windrower 10) and the right rear caster wheel 16 oriented slightly downwardly and to the left (e.g., with the dot shown leading the rearwardly and left movement of the right rear caster wheel 16) to effect a nearly one hundred-eighty right spin-around of the windrower 10, such as at a headlands in a field. In FIG. 3E, the orientations of the rear caster wheels 16 are reversed to effect a left-hand, spin-around. In FIG. 3F, straight, reverse movement of the windrower 10 is effected by the dual-path steering system 20 causing reverse, same speed rotation of the front drive wheels 14 while the rear caster wheels 16 are rotated around one hundred-eighty degrees to enable reverse direction travel (e.g., the dot is now shown in the rearward location, signifying that the rear caster wheels 16 have been rotated to enable rearward travel). Left, rearward and right, rearward travel is enabled by the dual-path steering system 20 adjusting the relative rotation of the front drive wheels 14 while the steering axle system 22 adjusts the steer angle of the rear caster wheels 16 to the left (e.g., viewed with the dot to the left of the longitudinal axis of the windrower 10) in FIG. 3G and to the right in FIG. 3H. Note that the above-described example depictions of the control of the front drive wheels 14 and rear caster wheels 16 are merely illustrative, and that other orientations of the rear caster wheels 16 may be achieved through the appropriate steer commands to realize the desired turn of the windrower 10.

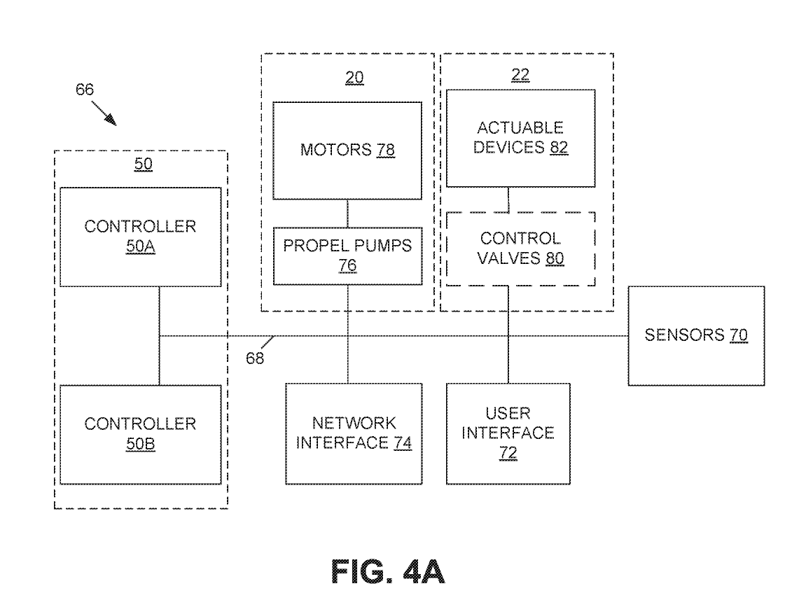

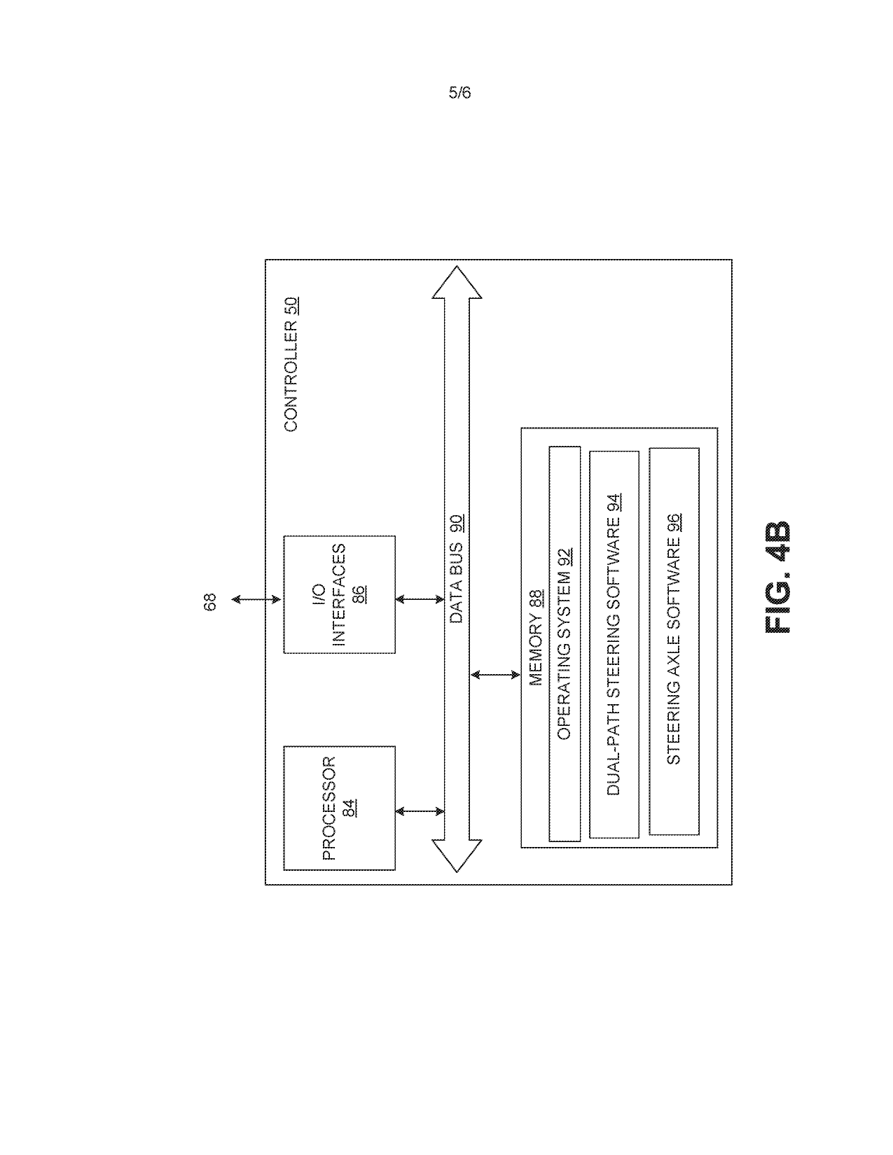

Having described some example operations of a steering axle system 22 used in cooperation with a dual-path steering system 20, attention is directed to FIG. 4A, which illustrates an example control system 66 for a steering system comprising an embodiment of the steering axle system 22. For instance, the control system 66 provides steering control for the dual-path steering system 20 and the steering axle system 22. It should be appreciated within the context of the present disclosure that some embodiments may include additional components or fewer or different components, and that the example depicted in FIG. 4A is merely illustrative of one embodiment among others. Further, in some embodiments, the control system 66 may be distributed among plural machines. For instance, sensing and/or actuation functionality may reside at least in part locally with the windrower 10 (FIG. 1) whereas the commands may be issued remotely (e.g., via a remote server in wireless communication with the windrower 10). The control system 66 comprises one or more controllers, such as the controllers 50A and 50B. In some embodiments, functionality of the controllers 50A and 50B may be combined (collectively referred to as controller 50, and as optionally represented by a dashed box outlining controllers 50A and 50B). The controllers 50A and 50B are coupled via one or more networks, such as network 68 (e.g., a CAN network or other network, such as a network in conformance to the ISO 11783 standard, also referred to as “Isobus”), to actuable devices of the dual-path steering system 20 and the steering axle system 22, plural sensors 70 (which may include sensors 64 of the steering axle system 22 and sensors used to sense steering wheel and/or FNR lever movement for the dual-path steering system 20, among other sensors of the windrower 10), a user interface 72, and a network interface 74. Note that architecture depicted in FIG. 4A involves the sharing by the controllers 50A and 50B of the same bus(es), though in some embodiments, other architectures may be used, such as the controllers 50A and 50B daisy-chained such that all information (e.g., sensor input, etc.) is relayed to the controller 50B serving in a slave function via the controller 50A serving in a master function (or vice versa), or in some embodiments, the controllers 50A and 50B may function in a peer-to-peer relationship, where input to and from the actuators 52 and manifold(s) 60 of the steering axle system 22 and the associated sensors (e.g., sensors 64) communicate (e.g., solely) with the controller 50B, whereas the dual-path steering system 20 communicates (e.g., solely) with the controller 50A. As indicated above, functionality of the controllers 50A and 50B may be combined into a single packaged unit, or distributed among additional components. These and/or other variations in the architecture may be implemented, and hence are contemplated to be within the scope of the disclosure.

With continued reference to FIG. 4A, the dual-path steering system 20 includes propel pumps 76 (which may be embodied as propel pumps 38 and 44, FIG. 1) and the wheel drive motors 78 (which may be embodied as wheel drive motors 40 and 46, FIG. 1), and associated fluid media or conduits (e.g., hydraulic fluid lines 42, 48, FIG. 1). In one embodiment, the controller 50A communicates commands to control portions for these devices, including solenoids, power and control terminals, switches, etc. to effect actuation (e.g., power on/off, valve open/closed, etc.) of the pumps 76 and/or motors 78, according to known control functionality. The steering axle system 22 comprises the control valves 80 of the manifold(s) 60 (FIG. 1), such as for fluid-power actuation, and actuable devices 82. The actuable devices 82 may include the actuators 52 (FIG. 1), or electric, hydraulic, pneumatic, magnetic, or electromagnetic motors in some embodiments. In some embodiments, the control valves 80 may be omitted, such as when electric and/or magnetic actuation is used (e.g., electric actuators, which may receive signals directly from the controller 50B, or indirectly through one or more electrical or electromagnetic components, including relays, switches, etc.).

As indicated above, the sensors 70 include position sensors of the user interface 72 (e.g., FNR lever and steering wheel), as well as the sensors 64 that monitor the left and right rear caster angle positions (among other sensors, such as those used to monitor speed of travel, engine load, etc.). The sensors 70 may be embodied as non-contact (e.g., imaging, Doppler, acoustic, terrestrial or satellite based, among other wavelengths, inertial sensors, etc.) and/or contact-type sensors (e.g., pressure transducers, speed sensors, Hall effect, position sensors, strain gauge, etc.), all of which comprise known technology. The user interface 72 may include one or more of a keyboard, mouse, microphone, touch-type display device, joystick, steering wheel, FNR lever, or other devices (e.g., switches, immersive head set, etc.) that enable input and/or output by an operator (e.g., to respond to indications presented on the screen or aurally presented) and/or enable monitoring of machine operations.

The network interface 74 comprises hardware and/or software that enable wireless connection to one or more remotely located computing devices over a network (e.g., wireless or mixed wireless and wired networks). For instance, the network interface 74 may cooperate with browser software or other software of the controllers 50A and/or 50B to communicate with a server device over cellular links, among other telephony communication mechanisms and radio frequency communications, enabling remote monitoring or control of the windrower 10 (FIG. 1). The network interface 104 may comprise MAC and PHY components (e.g., radio circuitry, including transceivers, antennas, radio modems, cellular modems, etc.), as should be appreciated by one having ordinary skill in the art.

In one embodiment, the controllers 50A and/or 50B are configured to receive and process information from the sensors 70, and communicate with actuable or control devices of the dual-path steering system 20 and the steering axle system 22 to cause the desired navigational movement of the windrower 10 (FIG. 1) based on the input of information from the sensors 70 (e.g., as prompted by sensed movement of components of the user interface 72, which may be prompted by an operator or occur automatically, and sensed rear caster wheel steering angles). In some embodiments, the controllers 50A and/or 50B may provide feedback of steering operations via the user interface 72 (e.g., presented visually, aurally, and/or haptically).

FIG. 4B further illustrates an example embodiment of the controller 50, which combines functionality of the controllers 50A and 50B. In some embodiments, functionality described below for the controller 50 may be distributed among the controllers 50A and 50B. In other words, functionality of the control (e.g., executable code) for the dual-path steering system 20 and functionality of the control (e.g., executable code) for the steering axle system 22 are described below as residing within a single controller 50, with the understanding that respective functionality may be distributed among plural controllers (e.g., 50A, 50B) with communication enabled between the controllers 50A, 50B via the network 68 to enable cooperative functionality for steering. One having ordinary skill in the art should appreciate in the context of the present disclosure that the example controller 50 is merely illustrative, and that some embodiments of controllers may comprise fewer or additional components, and/or some of the functionality associated with the various components depicted in FIG. 4B may be combined, or further distributed among additional modules, in some embodiments. Also, in embodiments where there are multiple controllers (e.g., 50A, 50B), the architecture described below for the controller 50 is applicable to the controllers 50A and 50B, with in some embodiments a reduced instruction set for each enabled based on the role of each controller in effecting functionality for the respective dual-path steering system 20 and the steering axle system 22. It should be appreciated that, though described in the context of residing entirely within the windrower 10 (FIG. 1), in some embodiments, all or a portion of the functionality of the controller 50 may be implemented in a computing device or system located external to the windrower 10 yet in communication with the windrower 10 (e.g., via network interface 74).

Referring to FIG. 4B, the controller 50 is depicted in this example as a computer system, but may be embodied as a programmable logic controller (PLC), field programmable gate array (FPGA), application specific integrated circuit (ASIC), among other devices. It should be appreciated that certain well-known components of computer systems are omitted here to avoid obfuscating relevant features of the controller 50. In one embodiment, the controller 50 comprises one or more processors (also referred to herein as processor units or processing units), such as processor 84, input/output (I/O) interface(s) 86, and memory 88, all coupled to one or more data busses, such as data bus 90. The memory 88 may include any one or a combination of volatile memory elements (e.g., random-access memory RAM, such as DRAM, SRAM, and SDRAM, etc.) and nonvolatile memory elements (e.g., ROM, Flash, solid state, EPROM, EEPROM, hard drive, CDROM, etc.). The memory 88 may store a native operating system, one or more native applications, emulation systems, or emulated applications for any of a variety of operating systems and/or emulated hardware platforms, emulated operating systems, etc. In some embodiments, a separate storage device may be coupled to the data bus 90, such as a persistent memory (e.g., optical, magnetic, and/or semiconductor memory and associated drives).

In the embodiment depicted in FIG. 4B, the memory 88 comprises an operating system 92, dual-path steering software 94, and steering axle software 96. The dual-path steering software 94 receives one or more inputs corresponding the steering wheel position and the FNR lever position (e.g., from sensors 70 associated with detecting the aforementioned user interface positions). The dual-path steering software 94 controls operation of the drive wheels 14 based on the input. For instance, the dual-path steering software 94 determines whether the neutral position is selected by the operator (e.g., corresponding to the FNR lever) to determine whether to implement zero radius functionality, and also determines a turning radius based on the steering wheel position according to mechanisms well-known in the art. Based on the aforementioned determinations, the dual-path steering software 94 issues steering commands directly or indirectly to the propel pumps and 76 and/or the wheel drive motors to effect the desired turning command (e.g., speed and direction of rotation). In one embodiment, the steering axle software 96 receives signals from the dual-path steering software 94 and the sensors 70 (e.g., sensors 64, FIG. 1) to enable steering angle computations and to issue steer commands directly or indirectly to the control valves 80 and/or the actuable devices 82. The signals from the dual-path steering software 94 may include the determinations made by the dual-path steering software 94 to enable computation by the steering axle software 96 of matching rear caster wheel angles to effect the requested turn in cooperation (e.g., in synchronization and conjunction with the adjusted rotations of the front drive wheels 14, such as illustrated in FIGS. 3A-3H). In some embodiments, the steering axle software 96 may receive the same inputs that the dual-path steering software 94 receives in addition to the current rear caster wheel angle input from sensors 64 (or in some embodiments, the controller 50A may also receive the sensor input from sensors 64, such as when responsible for computations of steering commands for both the dual-path steering system 20 and the steering axle system 22) to compute the steering angle adjustment for the rear caster wheels 16 to match the steering computations (rotational speed and direction adjustment) for the front drive wheels 14 to effect the desired turning ratio. These and/or other variations for coordinating the control of the steering achieved by the cooperation of the dual-path steering system 20 and the steering axle system 22 may be used, as should be appreciated by one having ordinary skill in the art in the context of the present disclosure, and hence are contemplated to be within the scope of the disclosure.

Execution of the dual-path steering software 94 and the steering axle software 96 may be implemented by the processor 84 under the management and/or control of the operating system 92. In some embodiments, the operating system 92 may be omitted and a more rudimentary manner of control implemented. The processor 84 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 50.

The I/O interfaces 86 provide one or more interfaces to the network 68 and other networks. In other words, the I/O interfaces 86 may comprise any number of interfaces for the input and output of signals (e.g., analog or digital data) for conveyance of information (e.g., data) over the network 68. The input may comprise input by a local operator through the user interface 72 and network 68, remote input from a remote device (e.g., server) via the network interface 74 and the network 68, and/or input from signals carrying information from one or more of the components of the dual-path steering system 20 and/or the steering axle system 22, including the respective sensors 102, among other devices.

When certain embodiments of the controller 50 (or controllers 50A, 50B) are implemented at least in part with software (including firmware), as depicted in FIG. 4B, it should be noted that the dual-path steering software 94 and the steering axle software 96 can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 50 (or controllers 50A, 50B) are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

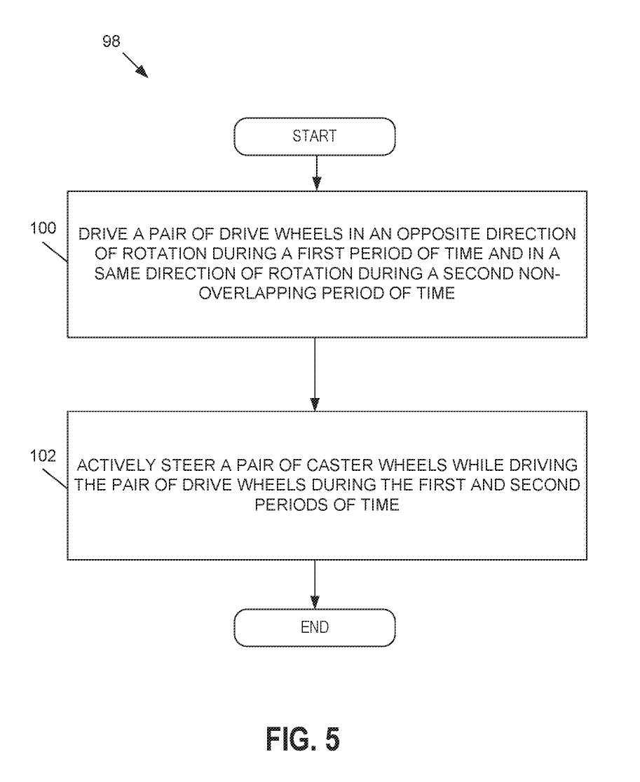

In view of the above description, it should be appreciated that one embodiment of a method of steering 98, the method depicted in FIG. 5, comprises driving a pair of drive wheels in an opposite direction of rotation during a first period of time and in a same direction of rotation during a second non-overlapping period of time (100); and actively steering a pair of caster wheels while driving the pair of drive wheels during the first and second periods of time (102). Actively steering refers to the fact that there is a persistent, controlled steer to the rear caster wheels at all times during field or road operations (as opposed to movement that is without restraint, as in conventional caster wheels for windrowers).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the control systems and methods have been described with reference to the example embodiments illustrated in the attached drawing figures, it is noted that equivalents may be employed and substitutions made herein without departing from the scope of the disclosure as protected by the following claims.

At least the following is claimed:

1. A windrower, comprising:
a dual-path steering system configured to drive a pair of drive wheels in an opposite direction of rotation and in a same direction of rotation during non-overlapping time periods; and
a steering axle system configured to actively steer a pair of caster wheels while the dual-path steering system drives the pair of drive wheels during each of the non-overlapping time periods.

2. The windrower of claim 1, wherein the steering axle system comprises an axle and first and second rear wheel attachments coupled respectively to opposing ends of the axle.

3. The windrower of claim 2, wherein the first rear wheel attachment is coupled to a first caster wheel of the pair of caster wheels and the second rear wheel attachment is coupled to a second caster wheel of the pair of caster wheels, the first and second caster wheels centered beneath the axle.

4. The windrower of claim 3, wherein the steering axle system further comprises first and second actuators, the first and second actuators operably coupled to the first and second rear wheel attachments, respectively, wherein the first and second actuators are configured to cause rotation of the first and second rear wheel attachments, respectively.

5. The windrower of claim 4, wherein the rotation ranges between zero and one hundred-eighty degree rotation.

6. The windrower of claim 4, wherein the rotation ranges between zero and three hundred-sixty degree rotation.

7. The windrower of claim 4, wherein the first and second actuators each includes any one of a hydraulic cylinder, a pneumatic cylinder, or an electric cylinder.

8. The windrower of claim 4, wherein the first and second actuators each includes any one of a hydraulic motor, a pneumatic motor, or an electric motor.

9. The windrower of claim 4, wherein the steering axle system further comprises first and second gear sets, wherein the first and second actuators respectively cause rotation of the first and second rear wheel attachments via actuation of the first and second gear sets, respectively.

10. The windrower of claim 4, wherein the steering axle system further comprises first and second crank assemblies, wherein the first and second actuators respectively cause rotation of the first and second rear wheel attachments via actuation of the first and second crank assemblies, respectively.

11. The windrower of claim 4, further comprising a controller, the controller configured to provide one or more steer commands to each of the first and second actuators to cause active steering of the respective first and second caster wheels during the non-overlapping time periods.

12. The windrower of claim 11, further comprising plural sensors, wherein the controller is configured to provide the one or more steer commands based on signals from the plural sensors.

13. A steering system, comprising:
a pair of drive wheels configured to be driven in an opposite direction of rotation and in a same direction of rotation during non-overlapping time periods;
an axle;
a pair of rear wheel attachments rotatably coupled to opposing ends of the axle; and
a pair of caster wheels operably coupled to the respective pair of rear wheel attachments, the pair of caster wheels centered beneath the axle.

14. The steering system of claim 13, further comprising plural actuators operably and respectively coupled to the pair of rear wheel attachment, wherein each of the plural actuators are configured to cause rotation of a respective rear wheel attachment of the pair of rear wheel attachments.

15. The steering system of claim 14, wherein the rotation ranges between zero and either one hundred-eighty degree rotation or three hundred-sixty degree rotation.

16. The steering system of claim 14, wherein each of the plural actuators includes any one of a hydraulic cylinder, a pneumatic cylinder, an electric cylinder, a hydraulic motor, a pneumatic motor, or an electric motor.

17. The steering system of claim 14, further comprising any one of plural gear sets or plural crank assemblies, wherein each of the plural actuators is configured to cause rotation of the respective rear wheel attachment of the pair of rear wheel attachments via actuation of either the respective gear set of the plural gear sets or the respective crank assembly of the plural crank assemblies.

18. The steering system of claim 14, further comprising a controller configured to provide one or more steer commands to each of the plural actuators to cause rotation of a respective rear wheel attachment of the pair of rear wheel attachments.

19. The steering system of claim 18, further comprising plural sensors, wherein the controller is further configured to provide the one or more steer commands based on signals from one or more of the plural sensors.

20. A method of steering, the method comprising:
driving a pair of drive wheels in an opposite direction of rotation during a first period of time and in a same direction of rotation during a second non-overlapping period of time; and
actively steering a pair of caster wheels while driving the pair of drive wheels during the first and second periods of time.
